(19) United States
(12) Patent Application Publication
(10) Pub. No.: US 2017/0232629 A1
(43) Pub. Date: Aug. 17, 2017

(54) PRODUCT SLICER

(71) Applicant: GLOBE FOOD EQUIPMENT COMPANY, DAYTON, OH (US)

(72) Inventors: Douglas J. McGuffin-Noll, Westerville, OH (US); Peter Dierauer, Jamestown, OH (US)

(21) Appl. No.: 15/042,179

(22) Filed: Feb. 12, 2016

(51) Int. Cl. B26D 7/01; B26D 1/143; B26D 7/06

(52) U.S. Cl. CPC B26D 7/01; B26D 7/0616; B26D 1/143; B26D 2210/02

(57) ABSTRACT

A product slicer having an adjustable gauge plate precisely positioned by the unique cooperation of a cam plate and a cam follower.

### CROSS-REFERENCE TO RELATED APPLICATIONS

Not applicable.

### STATEMENT REGARDING FEDERALLY SPONSORED RESEARCH OR TO DEVELOPMENT

This invention was not made as part of a federally sponsored research or development project.

### TECHNICAL FIELD

The present disclosure relates generally to adjustable thickness slicers and, more particularly, to food product slicers and the components associated with adjusting a gauge plate.

### BACKGROUND OF THE INVENTION

Typical reciprocating slicers have a rotatable, circular or disc-like slicing blade, an adjustable gauge plate for determining the thickness of the slice and a carriage for supporting the product as it is moved back and forth past the cutting edge of the knife during slicing. The gauge plate is situated along the edge of the knife toward the front of a slicing stroke and is laterally movable with respect to the knife for determining the thickness of the slices to be cut. A mechanism such as an adjustment handle for setting a spacing between the plane of the gauge plate surface and the plane of the knife edge for the purpose of slicing is also typically provided so that operators can select a thickness of slices to be produced. Movement of the gauge plate is generally a linear movement of the plane of the gauge plate relative to the plane of the knife edge. Thus, movement of the adjustment handle moves the gauge plate in a manner to make slice thickness adjustments.

Conventional gauge plate adjustment systems are plagued by backlash, or the ability to rotate the adjustment handle without producing any movement of the gauge plate, as well as coarse adjustability control when the gauge plate is nearest the plane of the knife, where it would ideally offer the finest adjustability control. Embodiments of the present invention address these weaknesses of conventional gauge plate adjustment systems.

### SUMMARY OF THE INVENTION

A product slicer having an adjustable gauge plate precisely positioned by the unique cooperation of a cam plate and a cam follower.

### BRIEF DESCRIPTION OF THE DRAWINGS

Without limiting the scope of the present invention as claimed below and referring now to the drawings and figures:

FIG. 1 shows an isometric view of a product slicer embodiment;

FIG. 2 shows a partial isometric view of a product slicer;

FIG. 3 shows an isometric view of a cam plate, a slider assembly, an adjustment handle and a partial housing;

FIG. 4 shows an isometric view of a cam plate, a slider assembly, an adjustment handle, a knife cover, a gauge plate and a partial housing;

FIG. 5 shows an exploded isometric view of a cam plate, a slider assembly, an adjustment handle and a partial housing;

FIG. 6 shows an exploded isometric view of a cam plate, a slider assembly, an adjustment handle, a gauge plate and a partial housing;

FIG. 7 shows another exploded isometric view of a cam plate, a slider assembly, an adjustment handle and a partial housing;

FIG. 8 shows a front elevation view of a cam plate embodiment;

FIG. 9 shows a cross sectional view of a cam plate embodiment;

FIG. 10 shows front and side elevation views of a cam follower embodiment;

FIG. 11 shows an isometric view of a slider assembly embodiment;

FIG. 12 shows an exploded isometric view of a slider assembly embodiment;

FIG. 13 shows an exploded isometric view of an embodiment having a cam-to-follower biasing mechanism, a cam plate and a slider assembly;

FIG. 14 shows embodiment of cam follower having a cam follower channel and another cross sectional view of a cam plate embodiment having a cam plate projection;

FIG. 15 shows another front elevation view of a cam plate embodiment;

FIG. 16 shows another front elevation view of a cam plate embodiment; and

FIG. 17 shows another front elevation view of a cam plate embodiment.

These drawings are provided to assist in the understanding of the exemplary embodiments of the invention as described in more detail below and should not be construed as unduly limiting the invention. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

The present invention enables a significant advance in the state of the art. The preferred embodiments of the invention accomplish this by new and novel arrangements of elements, materials, relationships, and methods that are configured in unique and novel ways and which demonstrate previously unavailable but preferred and desirable capabilities. The description set forth below in connection with the drawings is intended merely as a description of the presently preferred embodiments of the invention, and is not intended to represent the only form in which the present invention may be constructed or utilized. The description sets forth the designs, materials, functions, means, and methods of implementing the invention in connection with the illustrated embodiments. It is to be understood, however, that the same or equivalent functions, features, and material properties may be accomplished by different embodiments that are also intended to be encompassed within the spirit and scope of the invention. The present disclosure is described with reference to the accompanying drawings with preferred embodiments illustrated and described. The disclosure may, however, be embodied in many different forms and should not be construed as limited to the embodiments set forth herein; rather, these embodiments are provided so that this disclosure will be thorough and complete, and will fully convey the scope of the disclosure to those skilled in the art. Like numbers refer to like elements throughout the disclosure and the drawings. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

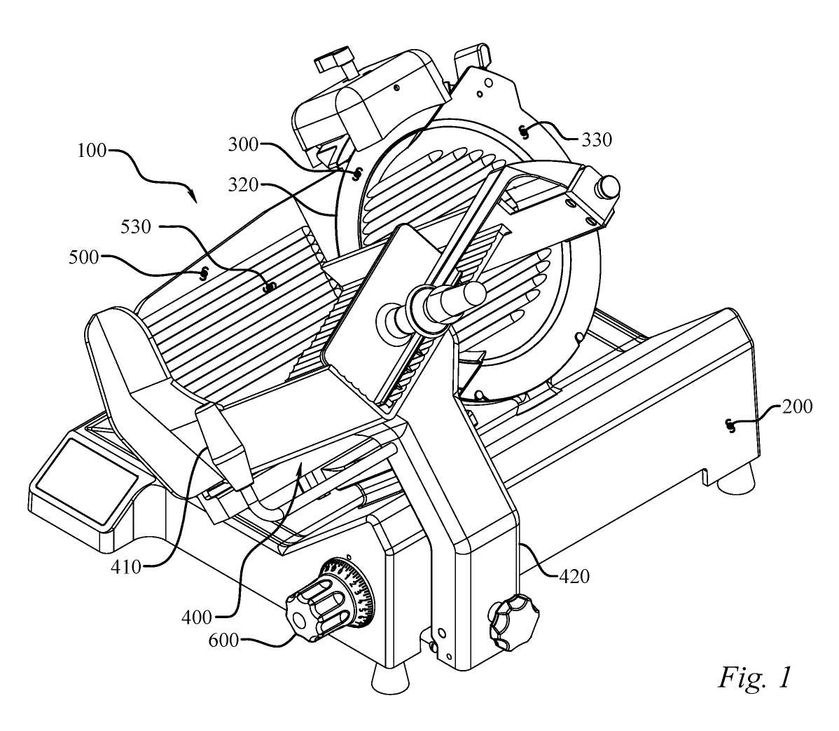

FIG. 1 represents an embodiment of a product slicer (100) having a housing (200) that acts as external shell of the product slicer (100). Furthermore, the housing (200) provides a mounting foundation onto which various product slicer (100) components are attached. Some components may attach to other assemblies and parts which ultimately connect to a portion of the housing (200), thus reference to components “mounted to” or “attached to” to the housing (200) simply means that the components are ultimately supported via the housing (200), which need not be a direct connection to the housing (200) but may be via connection to, or interaction with, other components.

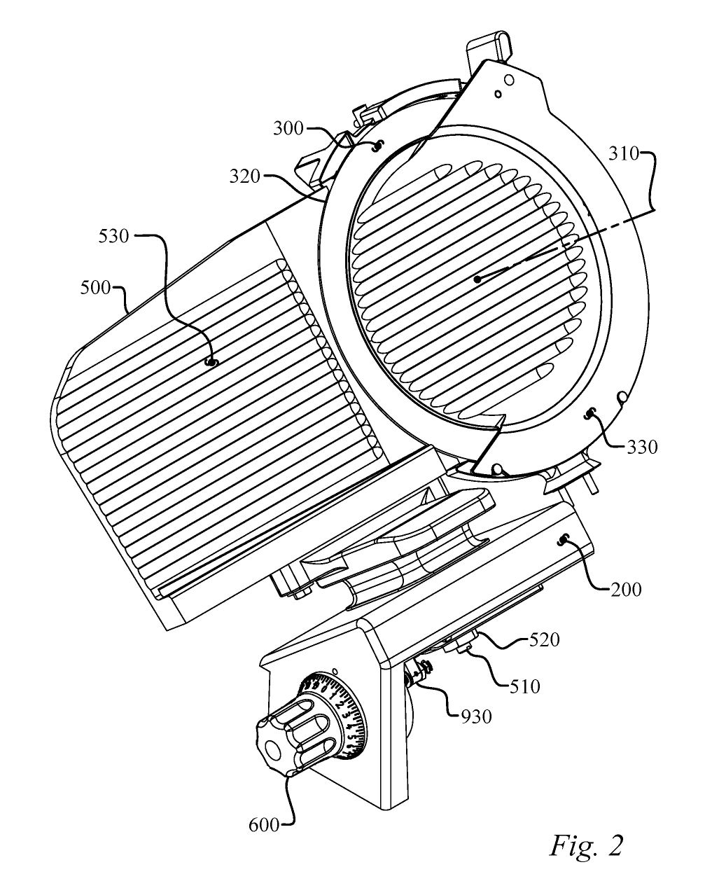

In addition to the housing (200) the product slicer (100) has a circular knife (300) mounted to the housing (200) which rotates about a knife axis (310) located in the center of the knife (300). Additionally, the knife (300) has a knife cutting edge (320) that is located around the knife's (300) perimeter which defines a knife cutting plane. The knife (300) may be covered by a knife cover (330), as seen in FIGS. 1 and 2, during use in order to prevent injury to the end user.

The product slicer (100) has a carriage assembly (400) is configured for reciprocating motion past the knife cutting edge (320) and is slidably attached by a carriage assembly arm (420) to the housing (200). The carriage assembly (400) may include a carriage assembly handle (410) which provides a hold point for the end user, as seen in FIG. 1. During use, the carriage assembly (400) cradles the product being sliced while reciprocating motion is provided manually by a user, or automatically by an electric motor, pneumatic motion system, or electromagnetic motion system.

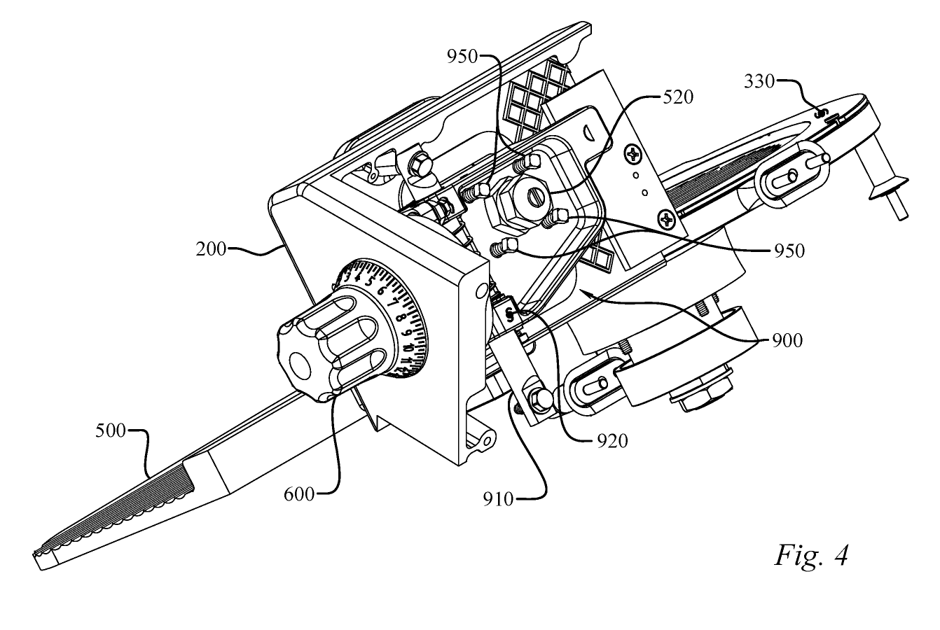

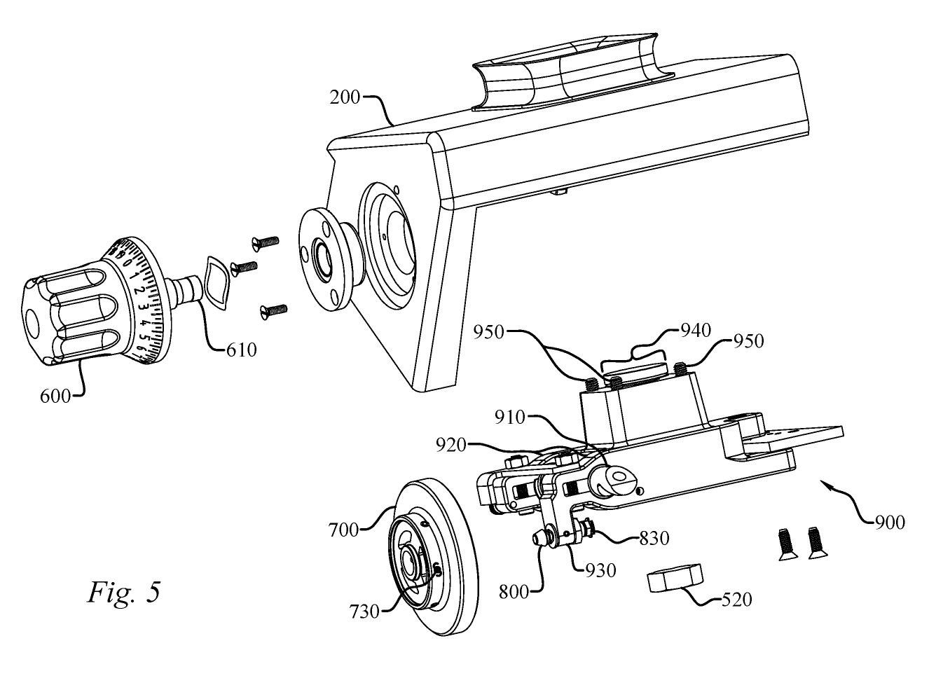

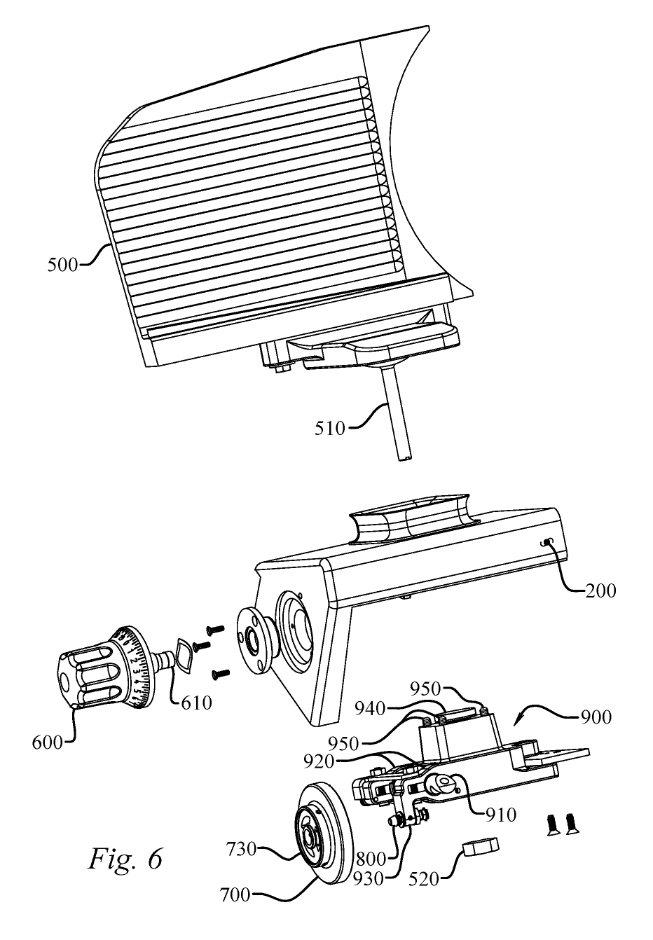

The variability of product slice thickness is obtained through the use of an adjustable gauge plate (500), which in some embodiments has a gauge plate mount (510) and a gauge plate mount nut (520). The gauge plate mount (510) joins the adjustable gauge plate (500) to a slider assembly (900), which may have a cooperating gauge plate receiver (940), as illustrated in FIGS. 2-7. In some embodiments the gauge plate receiver (940) mates with the gauge plate mount (510) and are attached together by the gauge plate mount nut (520). FIG. 6 shows an embodiment where the gauge plate mount (510) is a post extending from the gauge plate (500), which may pass through a portion of the housing (200), and the gauge plate receiver (940) is an aperture located on the slider assembly (900). In an alternative embodiment, not shown, the gauge plate mount (510) may receive a post extending from the slider assembly (900). The cam follower (800), the slider assembly (900), and the adjustable gauge plate (500) may each be separate and distinct components as illustrated in the figures, however the cam follower (800) may be an integral piece formed in the slider assembly (900), and the slider assembly (900) may be an integral portion of the adjustable gauge plate (500); in other words they need not be three separate and distinct pieces.

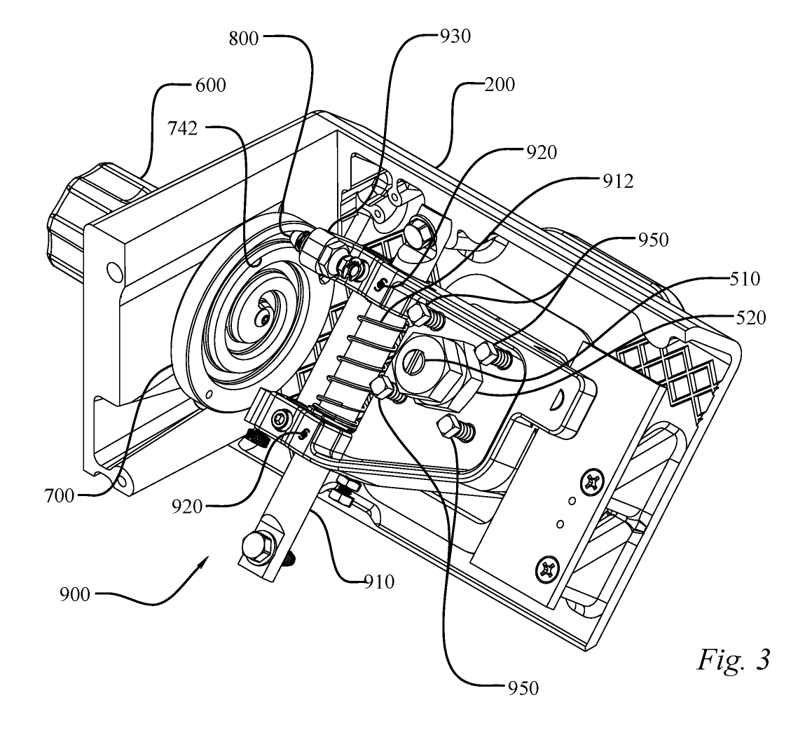

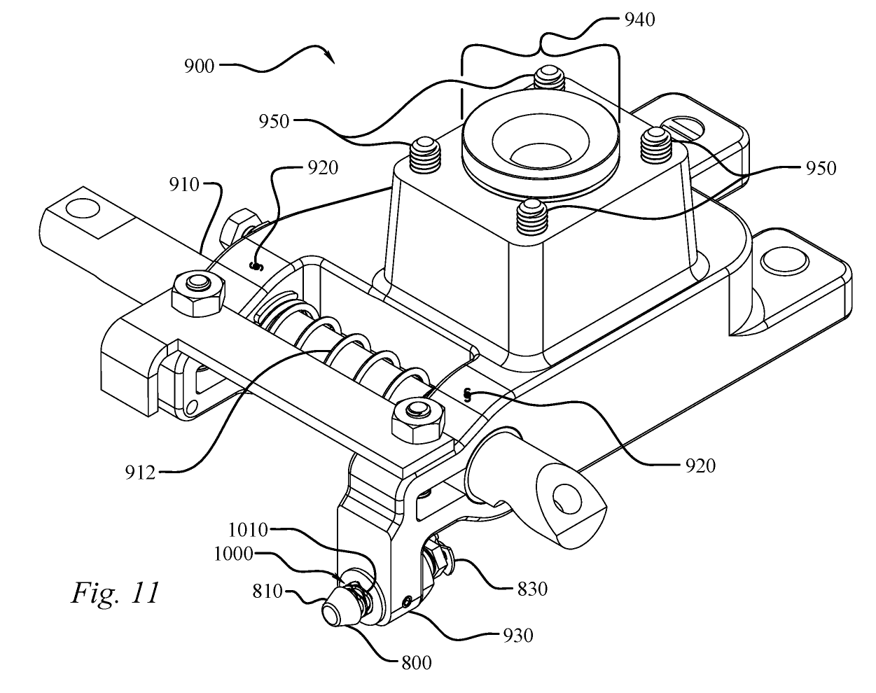

Now referring to FIGS. 3, 5, 11-13, the slider assembly (900) may include a slide rail (910) and a slide rail bias spring (912) that is located around the perimeter of the slide rail (910). The slide rail bias spring (912) biases the slider assembly (900), thereby preventing movement of the adjustable gauge plate (500) after the user selects a desired slice setting. The slide rail (910) is slidably coupled to the other components of the slider assembly (900) with mount brackets (920), which may include mount bracket bearings (922). The mount bracket bearings (922) allow for smooth low force linear travel of the slide rail (910) during the adjustment of the product slicer (100). The slider assembly (900) also has a set of gauge plate adjustment screws (950) that allows the gauge plate (500) to be aligned, or zeroed out, with the knife (300) cutting plane and establish the gauge plate initial position.

The gauge plate (500) may have a gauge plate bearing surface (530) onto which sliceable product rest while cradled in the carriage assembly (400). The bearing surface (530) need not be flat. Furthermore, the gauge plate (500) is configured so that the gauge plate bearing surface (530) is substantially parallel to the knife cutting plane. Additionally, the adjustable gauge plate (500) is adjustable in an adjustment direction, which in the figures is parallel to the knife axis (310), from a gauge plate initial position, with the gauge plate bearing surface (530) that is substantially in the knife cutting plane, to a gauge plate (500) slicing position where the gauge plate bearing surface (530) is offset from the knife cutting plane. The adjustment direction need not be parallel to the knife axis (310). The gauge plate (500) slicing position is not limited to one specific thickness but can be varied based upon the sliceable product and its intended use. For instance, a ham may be sliced in a thickness of less than half of a millimeter to created what is called shredded ham; the ham may be sliced at 1 to 3 millimeters to create sandwich slices; additionally, the ham may be sliced at 7 millimeters or more to created ham steaks.

In order to adjust the gauge plate (500) with respect to knife cutting plane, the product slicer (100) has an adjustment handle (600) rotably mounted to the housing (200), as seen in FIGS. 1, 2 and 4. The adjustment handle (600) may be connected to a cam plate (700) through an opening in the housing (200) by an adjustment handle shaft (610), as seen in FIGS. 3, 5-7, or vice versa, so that the cam plate (700) rotates in conjunction with the adjustment handle (600). The connection of the adjustment handle (600) to the cam plate (700) need not be a direct connection, rather it may include other components so that they are rotably connected (physically, electronically, pneumatically, or hydraulically), which need not need be in unison and may include a geared relationship, a belt-drive relationship, a chain-drive relationship, a friction drive relationship, or even a turn-by-wire relationship. Thus, references to the adjustment handle (600) need not be a handle in the traditional sense and may include touchscreen controls, touchpad controls, and/or buttons/keys that control the activation of a power drive system that in turn rotates the cam plate (700) to achieve the desired movement of the gauge plate (500). Therefore, all references to the rotation of the adjustment handle (600) to cause rotation of the cam plate (700) are equally disclosed with respect to entry of a command via touchscreen controls, touchpad controls, and/or buttons/keys. Further, one embodiment includes a gauge plate location sensor system that senses the location of the gauge plate (500); and a user may enter, or select, a desired thickness from the touchscreen controls, touchpad controls, and/or buttons/keys causing a drive system to rotate the cam plate (700) until the sensor system senses the desired thickness. In one embodiment the gauge plate location sensor system includes a sensor measuring the location of the gauge plate (700) in relation to the circular knife (300) or knife axis (310), and feeds the location data to a gauge plate controller in communication with the thickness input device (i.e. the touchscreen controls, touchpad controls, and/or buttons/keys), as well as the drive system, wherein the controller instructs the operation of the drive system to achieve the desired thickness.

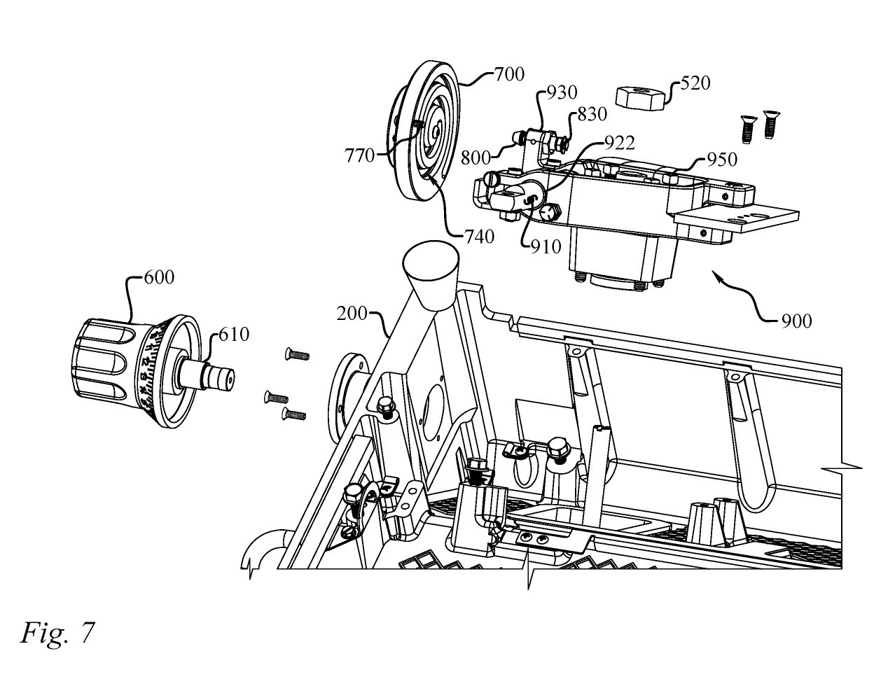

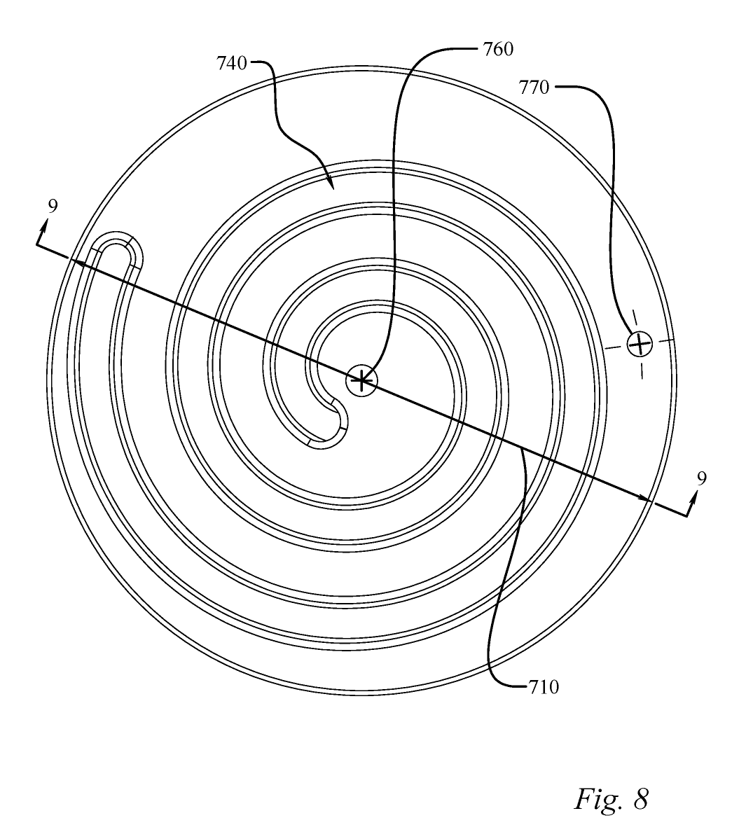

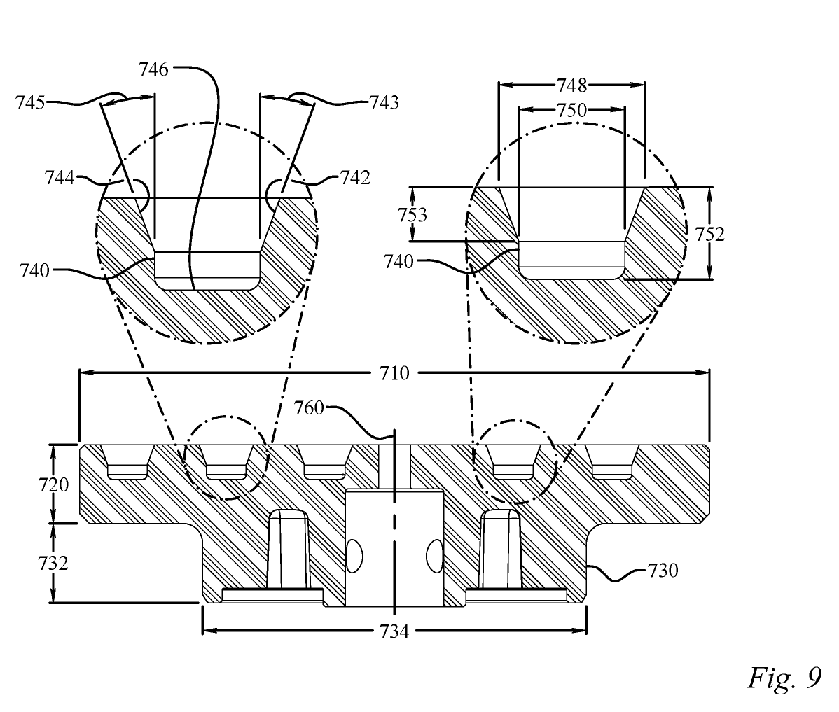

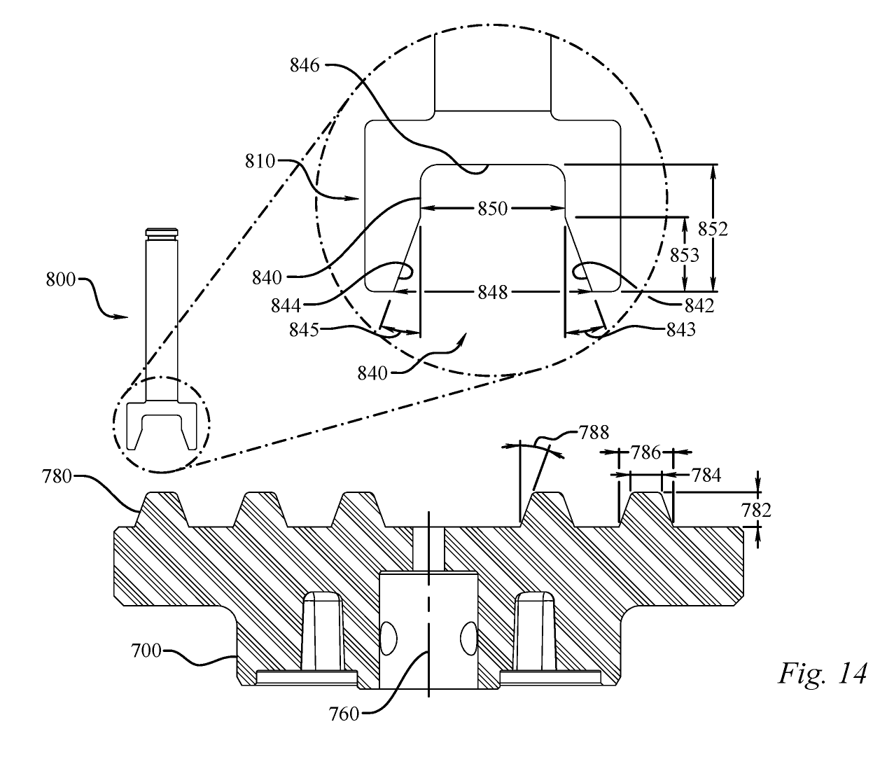

Now referring to FIGS. 8 and 9, the cam plate (700) may include a cam plate diameter (710), a cam plate thickness (720), a cam plate hub (730) with a cam plate hub thickness (732) and a cam plate hub diameter (734), a cam plate center axis (760), a cam plate center axis (760), and a cam plate turn limit (770). The cam plate hub (730) provides an attachment area for the adjustment handle shaft (610), alternatively the adjustment handle (600) may include a hub that proves an attachment area for a cam plate shaft. As the adjustment handle (600) is rotated, the cam plate (700) rotates about the cam plate's center axis (760). The cam plate (700) may include a cam plate turn limit (770), as illustrated in FIG. 7, to prevent damage to the product slicer (100) from overturning of the cam plate (700), and more specifically to prevent the cam follower (800) from getting to either end of the cam plate channel (740) and exit the cam plate channel (740), particularly in embodiments having angled cooperating surfaces on the cam plate channel (740) and the cam follower (800). Further, the cam plate (700) may include a cam plate channel (740), as seen in FIG. 9, or a cam plate projection (780), as seen in FIG. 14.

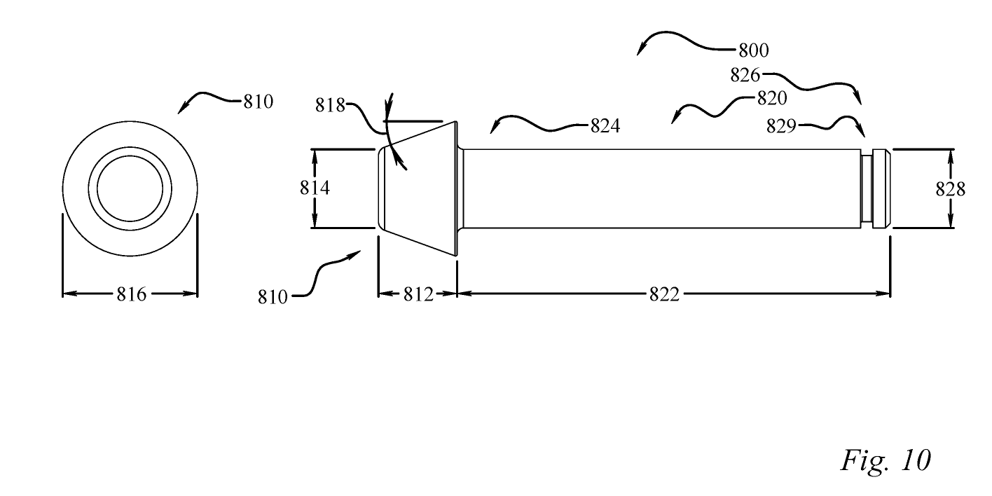

Now with reference to FIG. 10, in some embodiments the product slicer (100) has a cam follower (800) having a cam follower head (810) which engages the cam plate channel (740), as seen in FIG. 3. The cam follower (800) may include a cam follower stem (820), having a cam follower stem length (822), a cam follower stem proximal end (824), a cam follower stem distal end (826), a cam follower stem diameter (828), and a cam follower attachment engager (829). Furthermore, the cam follower (800) may be connected to the slider assembly (900) in a cam follower mounting bracket (930) with a cam follower retainer attachment (830) that engages the cam follower retainer attachment engager (829) located on the cam follower stem distal end (826), as seen in FIGS. 10-12. In turn, the slider assembly (900) is connected to the adjustable gauge plate (500).

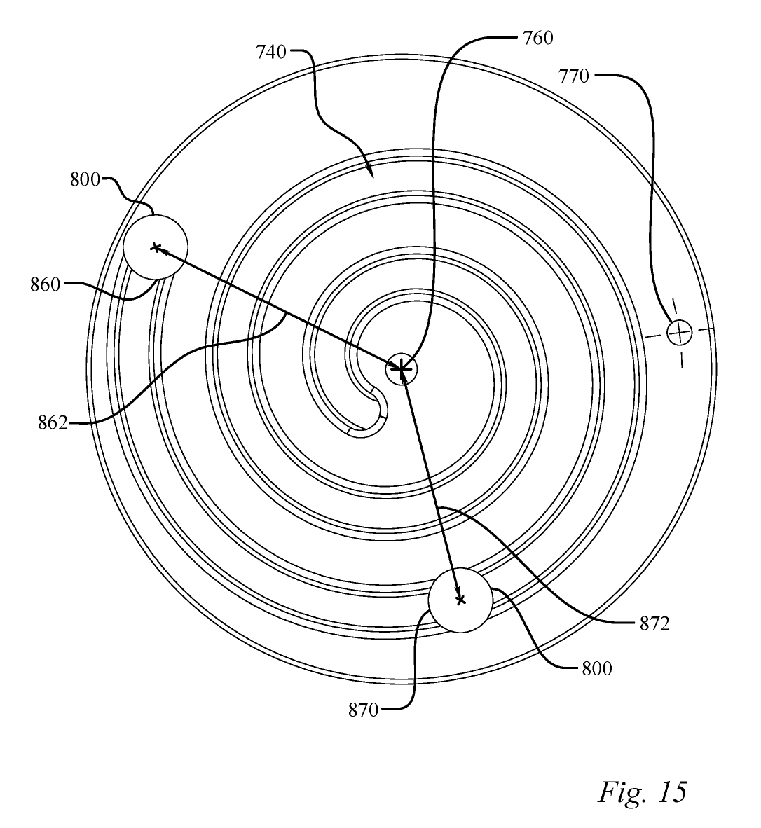

Now referring to FIG. 15, when the product slicer (100) is in the initial gauge plate position the cam follower head (810) engages the cam plate channel (740) at an initial cam head position (860). Rotation of the adjustment handle (600) causes rotation of the cam plate (700) thereby moving the cam follower head (810) within the cam plate channel (740) to a slicing cam head position (870). As a result, the repositioned cam follower (800) moves the slider assembly (900) and the adjustable gauge plate (500) to the gauge plate slicing position. Furthermore, the product slicer (100) has an initial head-to-cam-center distance (862), which is defined as the distance from the center of the initial cam head position to the cam plate center axis (760). The initial head-to-cam-center distance (862) is greater than a slicing head-to-cam-center distance (872), which is defined as the distance from the center of the slicing cam head position to the cam plate center axis (760). The reduction in length of the initial head-to-cam-center distance (862) to the slicing head-to-cam-center distance (872), as the adjustable gauge plate (500) moves from the gauge plate initial position to the gauge plate slicing position, with the gauge plate bearing surface (530) offset from the knife cutting plane, is opposite of conventional thinking and thereby provides improved performance and control of the placement of the adjustable gauge plate (500) when it is needed most, specifically as it initially starts to move away from the gauge plate initial position. In other words, rotation of the cam plate (700) results in the cam follower (800) moving from the initial cam head position (860) toward the cam plate center axis (760) to the slicing cam head position (870), as the gauge plate slicing position offset increases. Not only does this unique direction of travel provide increased fine level control of the position of the adjustable gauge plate (500) but it also tends to reduce backlash, characterized as the ability to rotate the adjustment handle (600) without producing corresponding movement of the gauge plate (500). Thus, reducing or eliminating backlash ensures that rotation of the adjustment handle (600) immediately results in movement of the gauge plate (500). One skilled in the art will appreciate that FIG. 15 illustrates the cam follower (800) moving circumferentially about the cam plate center axis (760) simply for ease in illustrating the key relationships, when in actuality it is the cam plate (700) that rotates causing the cam follower (800) to translate in a single direction.

Tables 1 and 2 below illustrate an embodiment of the relationship of the initial head-to-cam-center distance (862) and the slicing head-to-cam-center distance (872), for various rotations of the cam plate (700). The delta (Δ) column for each specific rotation value of the cam plate (700) is the initial head-to-cam-center distance (862) minus the slicing head-to-cam-center distance (872). The delta (Δ) values are always positive because the cam follower (800) moves from the initial cam head position (860), toward the cam plate center axis (760), to the slicing cam head position (870), unlike traditional systems that move in the opposite direction at the sacrifice of performance and fine-tuning control. In another embodiment in which adjustment handle (600) and the cam plate (700) are directly connected in a 1:1 relationship, Tables 1 and 2 below illustrate an embodiment of the relationship of the initial head-to-cam-center distance (862) and the slicing head-to-cam-center distance (872), for various rotations of the adjustment handle (600).

TABLE 1

| 0° | 45° | | 90° | | 135° | | 180° | |
|---|---|---|---|---|---|---|---|---|
| (862) | (872) | (Δ) | (872) | (Δ) | (872) | (Δ) | (872) | (Δ) |
| 1.748″ | 1.670″ | 0.078″ | 1.591″ | 0.157″ | 1.513″ | 0.235″ | 1.434″ | 0.314″ |

TABLE 2

| 0° | 225° | | 270° | | 315° | | 360° | |
|---|---|---|---|---|---|---|---|---|
| (862) | (872) | (Δ) | (872) | (Δ) | (872) | (Δ) | (872) | (Δ) |
| 1.748″ | 1.355″ | 0.393″ | 1.277″ | 0.471″ | 1.198″ | 0.550″ | 1.120″ | 0.628″ |

An advantage of this unique configuration is that a significant rotation of the cam plate (700), or adjustment handle (600), is required to produce a meaningful displacement of the adjustable gauge plate (500) from the gauge plate initial position to the gauge plate slicing position. In some embodiments the delta (Δ) value, which is the difference between the initial head-to-cam-center distance (862) and the slicing head-to-cam-center distance (872), directly correlates to the change in distance of the adjustable gauge plate (500) from the gauge plate initial position to the gauge plate slicing position. In one particular embodiment rotation of the adjustment handle (600) through any 45 degrees produces a change from the gauge plate initial position to the gauge plate slicing position of no more than 0.100 inch, and results in the slicing head-to-cam-center distance (872) being 2-8% less than the initial head-to-cam-center distance (862); and a further embodiment produces a change from the gauge plate initial position to the gauge plate slicing position of no more than 0.080 inch, and results in the slicing head-to-cam-center distance (872) being 3-6% less than the initial head-to-cam-center distance (862). In a further embodiment rotation of the adjustment handle (600) through any 90 degrees produces a change from the gauge plate initial position to the gauge plate slicing position of no more than 0.200 inch, and results in the slicing head-to-cam-center distance (872) being 4-16% less than the initial head-to-cam-center distance (862); and a further embodiment produces a change from the gauge plate initial position to the gauge plate slicing position of no more than 0.160 inch, and results in the slicing head-to-cam-center distance (872) being 6-12% less than the initial head-to-cam-center distance (862). In yet an even further embodiment wherein rotation of the adjustment handle (600) through any 180 degrees produces a change from the gauge plate initial position to the gauge plate slicing position of no more than 0.400 inch, and results in the slicing head-to-cam-center distance (872) being 8-32% less than the initial head-to-cam-center distance (862); and a further embodiment produces a change from the gauge plate initial position to the gauge plate slicing position of no more than 0.320 inch, and results in the slicing head-to-cam-center distance (872) being 12-24% less than the initial head-to-cam-center distance (862).

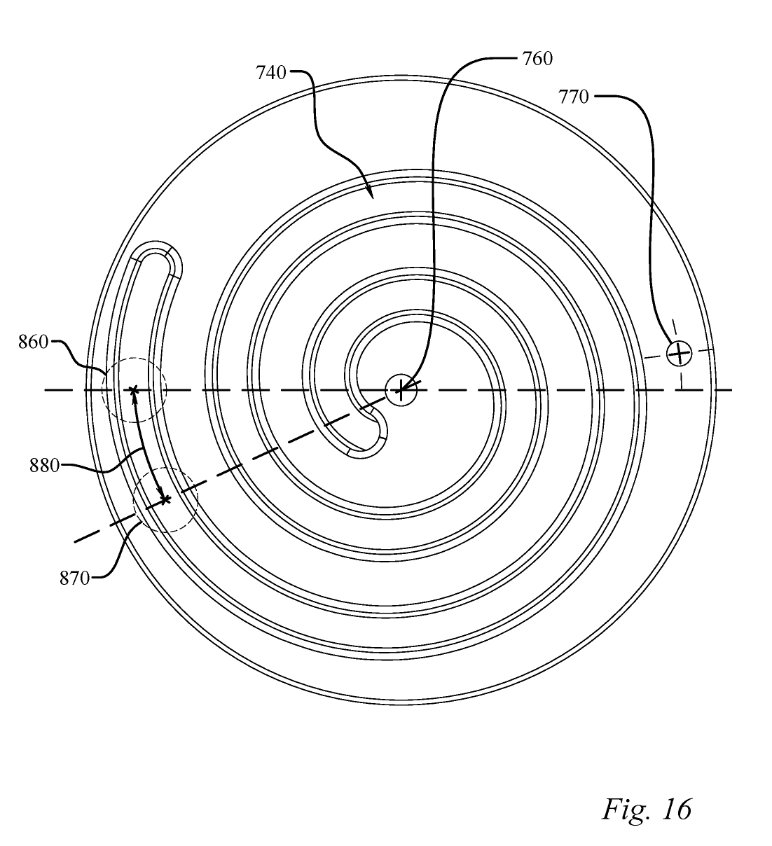

The relative change in position of the cam plate (700) to the cam follower (800) from the initial cam head position (860) to the slicing cam head position (870) is a travel length (880), illustrated in FIG. 16. In one embodiment the preferential control is achieved when the travel length (880) is relatively long compared to the difference from the initial head-to-cam-center distance (862) to the slicing head-to-cam-center distance (872), or delta (Δ) value; in other words, when an travel-delta ratio of the travel length (880) to the delta (Δ) value is high and the delta (Δ) value is positive. Similarly, preferential control is achieved when the travel length (880) is relatively long compared to rotation of the cam plate (700); in other words, when an travel-rotation ratio of the travel length (880) to the degrees of rotation of the cam plate (700), or slicing angle, associated with the movement from the initial cam head position (860) to the slicing cam head position (870), is high. Table 3 illustrates characteristics of this embodiment through the first 10 degrees of rotation of the cam plate (700).

TABLE 3
For FIG. 16

| 0° | 2.5° | | 5° | | 7.5° | | 10° | |
|---|---|---|---|---|---|---|---|---|
| (862) | (872) | (Δ) | (872) | (Δ) | (872) | (Δ) | (872) | (Δ) |
| 1.748″ | 1.744″ | 0.004″ | 1.739″ | 0.009″ | 1.735″ | 0.013″ | 1.731″ | 0.017″ |

| | | | | |
|---|---|---|---|---|
| (880) | 0.076″ | 0.152″ | 0.228″ | 0.304″ |
| (880)/(Δ) | 19.00 | 16.89 | 17.54 | 17.88 |
| (880)/(°) | 0.030 | 0.030 | 0.030 | 0.030 |

As seen in Table 3, in this embodiment the initial cam head position (860) is at 0 degrees and has an initial head-to-cam-center distance (862) of 1.748″. Once the cam plate (700) has rotated 2.5 degrees to a first slicing cam head position (870), a first slicing head-to-cam-center distance (872) is 1.744″, and therefore a first delta (Δ) value is a positive 0.004″, meaning that the rotation of the cam plate (700) results in the cam follower (800) moving closer to the cam plate center axis (760). Additionally, the relative motion of the center of the cam follower (800) and the cam plate (700) results in a first travel length (880) of 0.076″, which produces a first travel-delta ratio of 19.00 and a first travel-rotation ratio of 0.030. Similarly, once the cam plate (700) has rotated 5 degrees to a second slicing cam head position (870), a second slicing head-to-cam-center distance (872) is 1.739″, and therefore a second delta (Δ) value is a positive 0.009″. Additionally, the relative motion of the center of the cam follower (800) and the cam plate (700) results in a second travel length (880) of 0.152″, which produces a second travel-delta ratio of 16.89 and a second travel-rotation ratio of 0.030. Likewise, once the cam plate (700) has rotated 7.5 degrees to a third slicing cam head position (870), a third slicing head-to-cam-center distance (872) is 1.735″, and therefore a third delta (Δ) value is a positive 0.013″. Additionally, the relative motion of the center of the cam follower (800) and the cam plate (700) results in a third travel length (880) of 0.228″, which produces a third travel-delta ratio of 17.54 and a third travel-rotation ratio of 0.030. Finally, once the cam plate (700) has rotated 10 degrees to a fourth slicing cam head position (870), a fourth slicing head-to-cam-center distance (872) is 1.731″, and therefore a fourth delta (Δ) value is a positive 0.017″. Additionally, the relative motion of the center of the cam follower (800) and the cam plate (700) results in a fourth travel length (880) of 0.304″, which produces a fourth travel-delta ratio of 17.88 and a fourth travel-rotation ratio of 0.030.

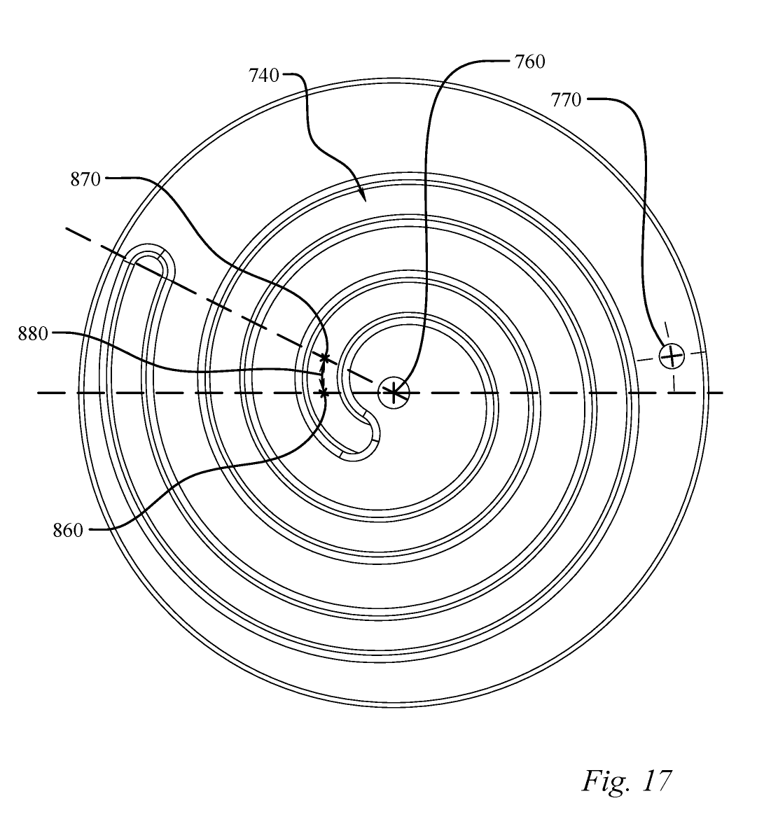

As previously touched upon, in some embodiments preferential control is achieved when the delta (Δ) value is a positive, the travel-delta ratio is high, or when an travel-rotation ratio is high, or a combination thereof. To appreciate the meaning of a high travel-delta ratio or a high travel-rotation ratio one must take a cursory look at embodiments wherein the delta (Δ) value is negative, meaning that rotation of the cam plate (700) causes the cam follower (800) to move away from the cam plate center axis (760) as the cam follower (800) goes from the initial cam head position (860) to the slicing cam head position (870), as seen in FIG. 17. Table 4 illustrates to characteristics of such a negative delta (Δ) value embodiment through the first 10 degrees of rotation of the cam plate (700).

TABLE 4
For FIG. 17

| 0° | 2.5° | | 5° | | 7.5° | | 10° | |
|---|---|---|---|---|---|---|---|---|
| (862) | (872) | (Δ) | (872) | (Δ) | (872) | (Δ) | (872) | (Δ) |
| 0.334″ | 0.339″ | −0.005″ | 0.343″ | −0.009″ | 0.348″ | −0.014″ | 0.352″ | −0.018″ |

| | | | | |
|---|---|---|---|---|
| (880) | 0.0129 | 0.01867 | 0.02827 | 0.03808 |
| (880)/(Δ) | −2.58 | −2.07 | −2.02 | −2.12 |
| (880)/(°) | 0.0052 | 0.0037 | 0.0038 | 0.0038 |

As seen in Table 4, in this negative delta (Δ) value embodiment the initial cam head position (860) is at 0 degrees and has an initial head-to-cam-center distance (862) of 0.334″. Once the cam plate (700) has rotated 2.5 degrees to a first slicing cam head position (870), a first slicing head-to-cam-center distance (872) is 0.339″, and therefore a first delta (Δ) value is a negative 0.005″, meaning that the rotation of the cam plate (700) results in the cam follower (800) moving away from the cam plate center axis (760). Additionally, the relative motion of the center of the cam follower (800) and the cam plate (700) results in a first travel length (880) of 0.0129″, which produces a first travel-delta ratio of −2.58 and a first travel-rotation ratio of 0.0052. Comparing these values with those of the positive delta (Δ) value embodiment of Table 3 illustrates that the same 2.5 degrees of cam plate (700) rotation yields (a) a first travel length (880) in Table 3 that is 5.89 times greater than the first travel length (880) in Table 4, (b) a first travel-delta ratio in Table 3 that is 7.36 times greater than the first travel-delta ratio in Table 4, and (c) a first travel-rotation ratio in Table 3 that is 5.77 times greater than the first travel-rotation ratio in Table 4. For the sake of brevity a similar discussion of the values at 5 degrees, 7.5 degrees, and 10 degrees of rotation in Table 4 is omitted.

In a first series of positive delta (Δ) value embodiments preferred control is achieved when the first 10 degrees of rotation of the cam plate (700) from the initial cam head position (860) has a travel length (880) that is at least 0.075″, while in a further embodiment it is at least 0.150″, and in an even further embodiment it is at least 0.225″. In a further series of embodiment the first 10 degrees of rotation of the cam plate (700) from the initial cam head position (860) also produces a travel length (880) that is less than 0.600″, while in a further embodiment it is less than 0.500″, and in an even further embodiment it is less than 0.400″.

In a second series of positive delta (Δ) value embodiments preferred control is achieved when the first 10 degrees of rotation of the cam plate (700) from the initial cam head position (860) has an travel-delta ratio that is positive and at least 3.0 throughout the entire 10 degree range, while in a further embodiment it is at least 5.0, and in an even further embodiment it is at least 10.0. In a further series of embodiments the first 10 degrees of rotation of the cam plate (700) from the initial cam head position (860) has an travel-delta ratio that is positive and less than 40, while in a further embodiment it is less than 30, and in an even further embodiment it is less than 25.

In a third series of positive delta (Δ) value embodiments preferred control is achieved when the first 10 degrees of rotation of the cam plate (700) from the initial cam head position (860) has an travel-rotation ratio that is at least 0.010 throughout the entire 10 degree range, while in a further embodiment it is at least 0.015, and in an even further embodiment it is at least 0.020. In a further series of embodiments the first 10 degrees of rotation of the cam plate (700) from the initial cam head position (860) has an travel-rotation ratio that is less than 0.100, while in a further embodiment it is less than 0.075, and in an even further embodiment it is less than 0.050.

In additional embodiments the relationships of the travel-rotation ratio and the travel-delta ratio disclosed with respect to “throughout the entire 10 degree range”, are also true throughout at least 45 degrees, and throughout at least 90 degrees in further embodiments, and throughout at least 180 degrees in even further embodiments, and throughout at least 360 degrees in a final series of embodiments.

In a fourth series of positive delta (Δ) value embodiments preferred control is achieved when for the first 45 degrees of rotation of the cam plate (700) from the initial cam head position (860), each slicing head-to-cam-center distance (872) is at least 25% of the cam plate diameter (710), while it is at least 30% in another embodiment, and at least 35% in yet another embodiment. In a fifth series of positive delta (Δ) value embodiments preferred control is achieved when for the first 90 degrees of rotation of the cam plate (700) from the initial cam head position (860), each slicing head-to-cam-center distance (872) is at least 25% of the cam plate diameter (710), while it is at least 30% in another embodiment, and at least 35% in yet another embodiment. In a sixth series of positive delta (Δ) value embodiments preferred control is achieved when for the first 180 degrees of rotation of the cam plate (700) from the initial cam head position (860), each slicing head-to-cam-center distance (872) is at least 20% of the cam plate diameter (710), while it is at least 25% in another embodiment, and at least 30% in yet another embodiment.

Such embodiments having long travel lengths (880) compared to the rotation of the cam plate (700), and thus the difference from the initial head-to-cam-center distance (862) to the slicing head-to-cam-center distance (872), or delta (Δ) value, and the criticality of the associated ranges and ratios, produce unexpected performance improvements characterized by finer and more accurate control, with reduced backlash and improved repeatability, in part because for a particular angular rotation of the cam plate (700) the travel length (880) is significantly increased over conventional systems, which is apparent when comparing FIGS. 16 and 17. Increasing the travel length (880) increases the contact area of the cam plate (700) and cam follower (800) throughout a given range of motion, which leads to smoother operation and reduction of the impact of any initial lurch that occurs upon initial rotation of the cam plate (700) when the initial resistance to rotation is overcome. For instance, if the initial lurch upon overcoming friction is 10% of the cam follower proximal head width (816) the impact is less in embodiments having longer travel lengths (880). Further, the increased travel length (880) reduces the likelihood of deformation of the cam plate (700) within the region of most common use. For instance, most food product slicing occurs with the adjustable gauge plate (500) moving from a gauge plate initial position, with the gauge plate bearing surface (530) that is substantially in the knife cutting plane, to a slicing position where the gauge plate bearing surface (530) is offset from the knife cutting plane by less than 0.125″. Therefore, this is where it is desirable to have the greatest level of control, and results in a region on the cam plate (700) that is most commonly in contact with the cam follower (800). Repetitive contact in this region may lead to wear and deformation, which is further compounded as the travel length (880) becomes more abbreviated.

One embodiment obtains such performance improving relationships through the use of a cam plate channel (740), as seen in FIGS. 8 and 9, or a cam plate projection (780), as seen in FIG. 14, that include a portion of a two-dimensional spiral. The portion of the spiral may include a logarithmic spiral, Archimedean spiral, Euler spiral, hyperbolic spiral, lituus, Fabonacci spiral, spiral of Theodorus, and/or the involute of a circle. In another embodiment the performance improving relationships are achieved through the use of a cam plate channel (740) or a cam plate projection (780) that simply includes a portion of a curve that varies in distance from the cam plate center axis (760). In one embodiment the portion of the spiral, or the portion of the curve, extend throughout at least 90 degrees of the cam plate (700), while in a further embodiment it extends throughout at least 180 degrees of the cam plate (700), while in an even further embodiment it extends throughout at least 225 degrees of the cam plate (700), and in yet another embodiment it extends throughout at least 270 degrees of the cam plate (700), and in still a further embodiment it extends throughout at least 315 degrees of the cam plate (700). Another embodiment achieves the performance improving relationships through the use of a cam plate channel (740) or a cam plate projection (780) that incorporates a portion of a straight line, or multiple straight line segments, that varies in distance from the cam plate center axis (760).

Additional performance improvements are achieved with embodiments incorporating unique cooperating geometries of the cam plate channel (740), or cam plate projection (780), and the cam follower (800) to further promote smooth operation and reduce backlash. Such cooperating geometries provide improved performance of both positive delta (Δ) value embodiments, such as that seen in FIG. 16, and negative delta (Δ) value embodiments, such as that seen in FIG. 17. For instance, in one embodiment, seen in FIG. 9, the cam plate channel (740) has a first channel sidewall (742), with at least a portion oriented at a first sidewall angle (743) greater than zero, and a second channel sidewall (744), with at least a portion oriented at a second sidewall angle (745) greater than zero. In such an embodiment the cam plate channel (740) may have a channel exterior width (748), a channel interior width (750), and in some embodiments a cam plate channel floor (746). Further, the cam follower (800) may have a cam follower head (810) with at least a portion of the cam follower head (810) having an angled head surface oriented at a cam follower pitch (818) that is greater than zero. The cam follower head (810) engages the cam plate channel (740), as seen in FIG. 3. The combination of a cam plate channel (740) having pitched sidewalls (742, 744) and the mating cam follower head (810) having with a corresponding cam follower pitch (818) allows for the compensation of cam plate channel (740) and cam follower head (810) due to wear, thereby reducing backlash.

Conversely, conventional straight walled cam plate channels and a pin-type cam follower suffer from wear to the cam plate channel and cam follower resulting in unwanted movement, or more precisely lack of movement—also referred to as backlash, in the gauge plate (500) due to additional play, or slop, between the cam plate channel and pin-type cam follower. Such conventional systems have a gap between the straight walled cam plate channels and the pin-type cam follower from the outset, and the gap increases overtime with use thereby increasing the undesirable attributes that plague such systems. In the current embodiment, wear to the cam plate channel (740) and cam follower head (810) reduces or eliminates backlash thereby producing movement in the gauge plate (500) with any rotation of the adjustment handle (600). As the surfaces of the cam plate channel (740) and/or cam follower head (810) wear, the pitched configuration of the cam plate channel (740) walls and cam follower head (810) compensate.

In a further embodiment the cam plate channel (740) has a first channel sidewall (742), with at least a portion oriented at a first sidewall angle (743) greater than five degrees, and a second channel sidewall (744), with at least a portion oriented at a second sidewall angle (745) greater than five degrees. In still a further embodiment at least a portion of the cam follower head (810) has a cam follower pitch (818) that is within 2.5 degrees of the first sidewall angle (743) and the second sidewall angle (745). The combination of a cam plate channel (740) having pitched sidewalls (742, 744) and the mating cam follower head (810) having with a cam follower pitch (818) that is within 2.5 degrees of the first sidewall angle (743) and the second sidewall angle (745) allows for the compensation of cam plate channel (740) and cam follower head (810) wear and further reduces backlash. A still further embodiment incorporates a cam plate channel (740) with at least a portion oriented at a first sidewall angle (743) of 5-45 degrees, and at least a portion oriented at a second sidewall angle (745) of 5-45 degrees. Likewise, in this embodiment, the cam follower (800) has a cam follower head (810) with at least a portion of the cam follower head (810) having an angled head surface oriented at a cam follower pitch (818) of 5-45 degrees to further compensate for wear of the cam plate channel (740) and cam follower (800). Another embodiment has a cam plate channel (740) with a first channel sidewall (742) having at least a portion oriented at a first sidewall angle (743) of 10-45 degrees, and a second channel sidewall (744) having at least a portion oriented at a second sidewall angle (745) of 10-45 degrees, as well as a cam follower (800) having a cam follower head (810) with at least a portion of the cam follower head (810) having an angled head surface oriented at a cam follower pitch (818) of 10-45 degrees. Still further, another embodiment has a cam plate channel (740) with a first channel sidewall (742) having at least a portion oriented at a first sidewall angle (743) of 15-45 degrees, and a second channel sidewall (744) having at least a portion oriented at a second sidewall angle (745) of 15-45 degrees, as well as a cam follower head (810) with at least a portion of the cam follower head (810) having an angled head surface oriented at a cam follower pitch (818) of 15-45 degrees; while another embodiment has a cam plate channel (740) with a first channel sidewall (742) having at least a portion oriented at a first sidewall angle (743) of 20-30 degrees, and a second channel sidewall (744) having at least a portion oriented at a second sidewall angle (745) of 20-30 degrees, as well as a cam follower head (810) with at least a portion of the cam follower head (810) having an angled head surface oriented at a cam follower pitch (818) of 20-30 degrees.

Now with reference to FIG. 10, in one embodiment the preceding geometric relationships are achieved by a cam follower (800) having a frustoconical cam follower head (810) having a cam follower distal head width (814) and a cam follower proximal head width (816), and wherein the cam follower distal head width (814) is at least 20% less than the cam follower proximal head width (816), while in a further embodiment the cam follower distal head width (814) is 20-60% less than the cam follower proximal head width (816), and in an even further embodiment the cam follower distal head width (814) is 30-50% less than the cam follower proximal head width (816). In another embodiment the cam follower proximal head width (816) is greater than the channel exterior width (748), as seen in FIG. 9, while in a further embodiment the cam follower proximal head width (816) is at least 10% greater than the channel exterior width (748), further accommodating wear while also ensuring the cam follower (800) does not bottom out in the cam plate channel (740) and introduce additional friction into the system. A further embodiment ensures a preferred contact between the cam follower (800) and the cam plate channel (740) by having a cam follower distal head width (814) is less than the channel interior width (750). Still another embodiment reduces the risk of bottoming out by incorporating a cam plate channel (740) having both a channel depth (752) and a channel converging sidewall depth (753), and the cam follower head (810) has a cam follower head length (812) that is less than the channel depth (752), while in a further embodiment the channel converging sidewall depth (753) is less than the cam follower head length (812). Preferential contact and reduced stress, while controlling friction and reduced backlash potential, are further achieved in an embodiment having a channel converging sidewall depth (753) that is at least 30% of the channel depth (752), while in another embodiment the channel converging sidewall depth (753) is at least 50% of the channel depth (752), and in yet a further embodiment the channel converging sidewall depth (753) is 30-75% of the channel depth (752). In one embodiment the channel exterior width (748) is 0.125″-0.500″, while in a further embodiment it is 0.175″-0.450″, and in an even further embodiment it is 0.200″-0.400″. Additionally, in another embodiment the channel depth (752) is 0.125″-0.500″, while in a further embodiment it is 0.175″-0.450″, and in an even further embodiment it is 0.200″-0.400″.

In one embodiment the channel exterior width (748) is no more than 15% of the cam plate diameter (710), and the channel depth (752) of FIG. 9, or the cam plate projection length (782) of FIG. 14, which is discussed in detail below, is no more than 60% of the cam plate thickness (720). In a further embodiment the channel exterior width (748) is no more than 10% of the cam plate diameter (710) and the channel depth (752), or the cam plate projection length (782), is no more than 50% of the cam plate thickness (720). In yet another embodiment the distance between adjacent cam plate channels (740), or projections (780), along the surface of the cam plate (700) and within a section passing through the cam plate center axis (760), it at least 50% of the channel exterior width (748) or the cam plate proximal projection width (786). Further, in another embodiment the distance between adjacent cam plate channels (740), or projections (780), along the surface of the cam plate (700) and within a section passing through the cam plate center axis (760), it 50-150% of the channel exterior width (748) or the cam plate proximal projection width (786), while in another embodiment it is 75-125% of the channel exterior width (748) or the cam plate proximal projection width (786). In another embodiment the cam plate hub thickness (732) is at least 50% of the cam plate thickness (720), while in a further embodiment the cam plate hub thickness (732) is 50-150% of the cam plate thickness (720), and in yet another embodiment the cam plate hub thickness (732) is 75-125% of the cam plate thickness (720). These relationships achieve preferred stress distribution throughout the cam plate (700) and increase durability by reducing areas of high stress concentration.

All of the previously described performance improvements achieved via the unique cooperating geometries of the cam plate channel (740) are also applicable to the cam plate projection (780) and the cam follower (800), as seen in FIG. 14. Thus, all of the disclosed relationships disclosed herein in relation to a cam plate channel (740), and movement of the cam follower (800), apply equally to cam plate projection (780) embodiments, which is also true of FIG. 8 and section line 9-9, which can be thought of as section line 14-14 in cam plate projection (780) embodiments such as that illustrated in FIG. 14. Here again these geometries and relationships promote smooth operation of the cam plate (700) and cam follower (800) interface, and reduce backlash. The cam plate projection (780) has a cam plate projection length (782), a cam plate distal projection width (784), a cam plate proximal projection width (786) and a cam plate projection pitch (788). As the adjustment handle (600) is rotated, the cam plate (700) rotates about the cam plate's center axis (760). In this embodiment the cam follower (800) has a cam follower head (810) that has a slotted configuration, as seen in FIG. 14. The cam follower head (810) has a cam follower channel (840) having a cam follower first channel sidewall (842), which has a cam follower first sidewall angle (843), a cam follower second channel sidewall (844), which has a cam follower second sidewall angle (845), and in some embodiments a cam follower channel floor (846). Furthermore, the cam follower channel (840) further includes a cam follower channel exterior width (848), a cam follower channel interior width (850), a cam follower channel depth (852), and a cam follower channel converging sidewall depth (853).

In one embodiment the cam follower first channel sidewall (842) has at least a portion with a cam follower first sidewall angle (843) greater than zero, and the cam follower second channel sidewall (844) has at least a portion with a cam follower second sidewall angle (845) greater than zero. Further, the cam plate projection (780) may have a portion with an angled projection surface oriented at a cam plate projection pitch (788) that is greater than zero. The combination of a cam follower (800) having pitched sidewalls (842, 844) and the mating cam plate projection (780) having with a corresponding cam plate projection pitch (788) allows for the compensation for wear and reduction of backlash. In the current embodiment, wear to the cam plate projection (780) and/or the cam follower (800) does not result in unwanted movement in the gauge plate (500). As the surfaces of the cam plate projection (780) and/or cam follower (800) wear, the pitched configuration of the sidewalls (842, 844) and the corresponding cam plate projection pitch (788) compensate.

In a further embodiment at least a portion of the cam follower first channel sidewall (842) is oriented at a cam follower first sidewall angle (843) of greater than five degrees, and at least a portion of the cam follower second channel sidewall (844) is oriented at a cam follower second sidewall angle (845) of greater than five degrees. In still a further embodiment at least a portion of the cam plate projection (780) has a cam plate projection pitch (788) that is within 2.5 degrees of the cam follower first sidewall angle (843) and the cam follower second sidewall angle (845). In a further embodiment at least a portion of the cam follower first channel sidewall (842) is oriented at a cam follower first sidewall angle (843) of 5-45 degrees, and at least a portion of the cam follower second channel sidewall (844) is oriented at a cam follower second sidewall angle (845) of 5-45 degrees. Likewise, in this embodiment, at least a portion of the cam plate projection (780) has a cam plate projection pitch (788) of 5-45 degrees. Another embodiment has at least a portion of the cam follower first channel sidewall (842) is oriented at a cam follower first sidewall angle (843) of 10-45 degrees, and at least a portion of the cam follower second channel sidewall (844) is oriented at a cam follower second sidewall angle (845) of 10-45 degrees. Likewise, in this embodiment, at least a portion of the cam plate projection (780) has a cam plate projection pitch (788) of 10-45 degrees. Still further, another embodiment has at least a portion of the cam follower first channel sidewall (842) is oriented at a cam follower first sidewall angle (843) of 15-45 degrees, and at least a portion of the cam follower second channel sidewall (844) is oriented at a cam follower second sidewall angle (845) of 15-45 degrees. Likewise, in this embodiment, at least a portion of the cam plate projection (780) has a cam plate projection pitch (788) of 15-45 degrees; while another embodiment has a cam follower first sidewall angle (843) of 20-30 degrees, and a cam follower second sidewall angle (845) of 20-30 degrees. Likewise, in this embodiment, at least a portion of the cam plate projection (780) has a cam plate projection pitch (788) of 20-30 degrees.

With continued reference to FIG. 14, in one embodiment the preceding geometric relationships are achieved by a cam plate projection (780) having a cam plate distal projection width (784) and a cam plate proximal projection width (786), and wherein the cam plate distal projection width (784) is at least 20% less than the cam plate proximal projection width (786), while in a further embodiment the cam plate distal projection width (784) is 20-60% less than the cam plate proximal projection width (786), and in an even further embodiment the cam plate distal projection width (784) is 30-50% less than the cam plate proximal projection width (786). In another embodiment the cam plate proximal projection width (786) is greater than the cam follower channel exterior width (848), while in a further embodiment the cam plate proximal projection width (786) is at least 10% greater than the cam follower channel exterior width (848), further accommodating wear while also ensuring the cam plate projection (780) does not bottom out in the cam follower channel (840) and introduce additional friction into the system. A further embodiment ensures a preferred contact between the cam follower (800) and the cam plate projection (780) by having a cam plate distal projection width (784) is less than the cam follower channel interior width (850). Still another embodiment reduces the risk of bottoming out by incorporating a cam follower channel (840) having both a cam follower channel depth (852) and a cam follower channel converging sidewall depth (853), and the cam plate projection (780) has a cam plate projection length (782) that is less than the cam follower channel depth (852), while in a further embodiment the cam follower channel converging sidewall depth (853) is less than the cam plate projection length (782). Preferential contact and reduced stress, while controlling friction and reduced backlash potential, are further achieved in an embodiment having a cam follower channel converging sidewall depth (853) that is at least 30% of the cam follower channel depth (852), while in another embodiment the cam follower channel converging sidewall depth (853) is at least 50% of the cam follower channel depth (852), and in yet a further embodiment the cam follower channel converging sidewall depth (853) is 30-75% of the cam follower channel depth (852).

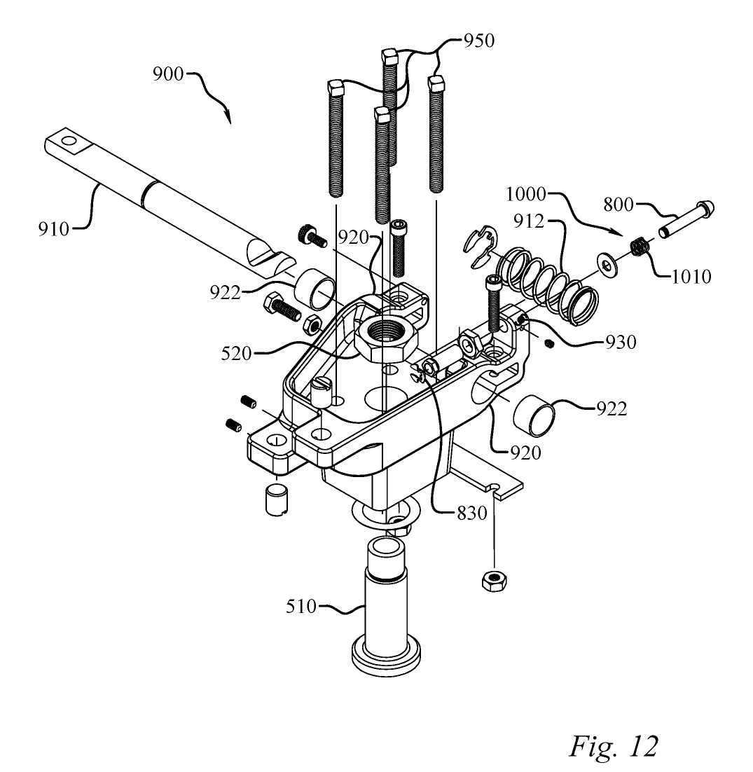

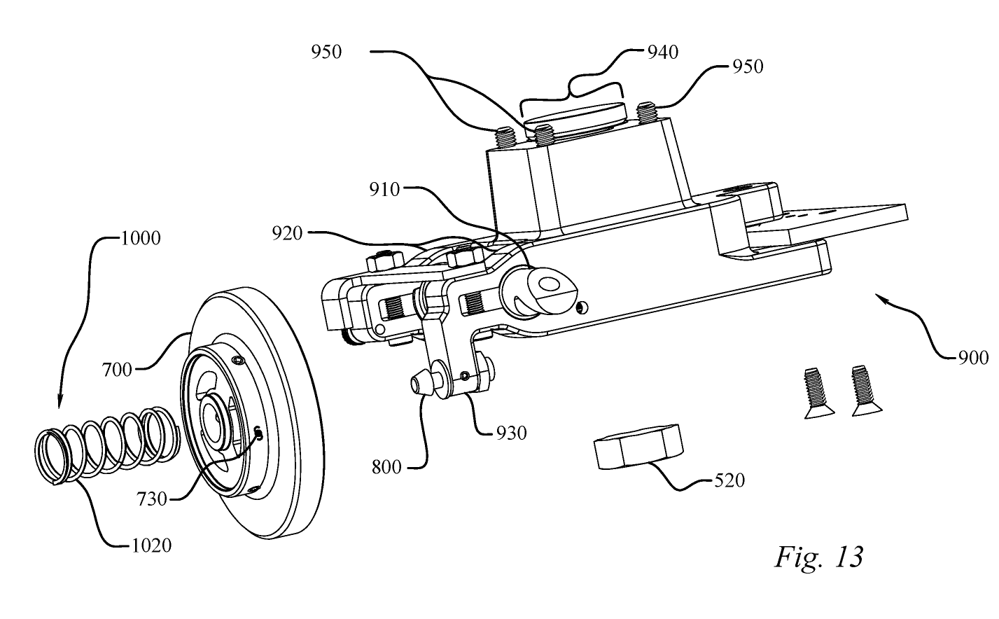

Wear accommodation, and backlash reduction, may be further reduced in embodiments incorporating a cam-to-follower biasing mechanism (1000) to bias the cam follower head (810) and the cam plate (700) against one another, as seen in FIGS. 12 and 13. In such embodiments, as the surfaces of the cam plate (700) and/or cam follower (800) wear, the pitched configuration of the sidewalls and the cam follower head compensate to ensure there is always contact between them. In one embodiment the cam-to-follower biasing mechanism (1000) includes a cam follower biasing mechanism (1010) that exerts a biasing force to force the cam follower (800) against the cam plate (700), as seen in FIG. 12. In another embodiment the cam-to-follower biasing mechanism (1000) includes a cam plate biasing mechanism (1020) that exerts a biasing force to force the cam plate (700) against the cam follower (800), as seen in FIG. 13. Yet a further embodiment incorporates both a cam follower biasing mechanism (1010) and a cam plate biasing mechanism (1020). Ensuring a relatively consistent force to bias the cam follower head (810) and the cam plate (700) against one another accommodates wear of the components and reduces the amount of play in the system thereby enhancing the control and reducing backlash. In one particular embodiment the biasing force is at least 2 lbf, while in a further embodiment the biasing force is less than 12 lbf, and in an even further embodiment the biasing force is 4-10 lbf, with is further narrowed in another embodiment to 6-8 lbf. In some embodiments the cam-to-follower biasing mechanism (1000) is adjustable so that the biasing force may be fine-tuned upon assembly, adjusted to a user's preference, and/or adjusted for component wear over time. For instance, as seen in FIG. 12, the position of the cam follower (800), and thus the cam follower head (810), is adjustable, which changes the amount that the cam follower biasing mechanism (1010) is compressed, thereby changing the biasing force. This is also true for embodiments having a cam plate biasing mechanism (1020). In one embodiment the adjustable cam-to-follower biasing mechanism (1000) is capable of changing the biasing force by at least 1 lbf; while in another embodiment is may change the biasing force by 1-8 lbf; and in yet a further embodiment it may change the biasing force by 2-4 lbf. Further, in one embodiment the biasing force is at least 2 lbf and is adjustable ±1 lbf; while in another embodiment the biasing force is 2-12 lbf and is adjustable ±6 lbf; and in yet a further embodiment the biasing force is 4-10 lbf and is adjustable ±3 lbf. These biasing forces and ranges achieve a delicate balance to provide the previously discussed benefits while not adding too much friction to the interface to cause binding of the components and allow for consistent smooth operation throughout the rotation of the cam plate (700), while accommodating for wear that is common during the life of a product slicer.

Smooth operation is further achieved in some embodiment through the use of dissimilar materials for the cam plate (700) and the cam follower (800) to further control where the wear occurs, achieve greater reduction of friction in the system, and improved durability. In one such embodiment at least one of the cam plate (700) and the cam follower (800) are formed of metallic material, and one of the cam plate (700) and the cam follower (800) are formed of non-metallic material. In one particular embodiment majority of the cam plate (700) is formed of a non-metallic material and the portion of the cam follower (800) in contact with the cam plate (700) is formed of a metallic material.

In one embodiment the non-metallic component is formed of a non-metallic material having a non-metallic material density of less than 2 grams per cubic centimeter and a tensile modulus of at least 4500 MPa (ISO 527-1/-2 test standard); while in a further embodiment the non-metallic material density of less than 1.5 grams per cubic centimeter and a tensile modulus of at least 5000 MPa (ISO 527-1/-2 test standard). In yet a further embodiment the non-metallic material has a non-metallic material tensile strength of at least 85 megapascal (ISO 527-1/-2 test standard), and a non-metallic material strain at break of at least 3.0% (ISO 527-1/-2 test standard); while in an even further embodiment the non-metallic material tensile strength of at least 90 megapascal (ISO 527-1/-2 test standard), and a non-metallic material strain at break of at least 4.0% (ISO 527-1/-2 test standard). In yet a further embodiment the non-metallic component tensile modulus is at least 2 percent of metallic component tensile modulus and the metallic material density is at least 3 times the non-metallic material density. In an even further embodiment a strain ratio of the metallic material strain at break to the non-metallic material strain at break is less than 25, while in an even further embodiment the strain ratio is less than 20. Conventional thinking would be to make the non-metallic component as strong as possible, which leads to a part formed of material having a high ultimate tensile strength, but one that is generally plagued by a strain at break of 2.5% or less, leading to a large strain ratio and resulting in durability issues. Focusing on unique strain relationships, rather than simply ultimate tensile strength, provide enhanced durability. Such a multi-material interface possessing these unique relationships among the materials achieves the desired durability and wear control, while promoting smooth operation of the interface.

In one embodiment the metallic component is formed of a metallic material having a metallic material density of greater than 4 grams per cubic centimeter and a tensile modulus of at least 150 GPa (ISO 527-1/-2 test standard); while in a further embodiment the metallic material density of at least 6 grams per cubic centimeter and a tensile modulus of at least 175 GPa (ISO 527-1/-2 test standard). In yet a further embodiment the metallic material has a metallic material tensile strength of at least 400 megapascal, and a metallic material strain at break of at least 50%; while in an even further embodiment the metallic material tensile strength of at least 450 megapascal, and a metallic material strain at break of at least 60%.

In a further embodiment the non-metallic component material includes a lubricating agent so that the non-metallic component is self-lubricating. In one embodiment the non-metallic component has a specific wear rate against steel of less than 10 (10⁻⁶ mm⁻³/Nm), wherein the specific wear rate was measured at low speed (0.084 m/s) with a contact pressure of 0.624 MPa in a reciprocating motion (total sliding distance: 4.25 km), while in a further embodiment the non-metallic component has a specific wear rate against steel of less than 7 (10⁻⁶ mm⁻³/Nm), and in an even further embodiment the non-metallic component has a specific wear rate against steel of less than 4 (10⁻⁶ mm⁻³/Nm). In another embodiment the non-metallic component material has a dynamic coefficient of friction against steel is less than 0.50, wherein the coefficient of friction was measured at a high speed (0.5 m/s) with a load of 10 N in a sliding motion (Block-on-Ring), while in a further embodiment the dynamic coefficient of friction against steel is less than 0.40, and less than 0.30 in an even further embodiment.

In one embodiment the non-metallic component is an engineering thermoplastic. In another embodiment the non-metallic component is composed primarily of a material selected from polyoxymethylene (POM), poly(methyl methacrylate) (PMMA), acrylonitrile butadiene styrene (ABS), polyamide, polylactic acid (polylactide), polybenzimidazole (PBI), polycarbonate (PC), polyether sulfone (PES), polyether ether ketone (PEEK), polyetherimide (PEI), polyethylene (polyethene, polythene, PE), polyphenylene oxide (PPO), polyphenylene sulfide (PPS), polypropylene (PP), polystyrene, polyvinyl chloride (PVC), polybutylene terephthalates (PBT), thermoplastic polyurethane (TPU), and semi-crystalline engineering resin systems that meet the claimed mechanical properties. In one embodiment the non-metallic material is a polyoxymethylene (POM) homopolymer, which in a further embodiment is an acetal resin. Further, the non-metallic material may be fiber reinforced. In one such embodiment the non-metallic material includes at least 5% fiber reinforcement. In one such embodiment the fiber reinforcement includes long-glass fibers having a length of at least 10 millimeters pre-molding and produce a finished component having fiber lengths of at least 3 millimeters, while another embodiment includes fiber reinforcement having short-glass fibers with a length of at least 0.5-2.0 millimeters pre-molding. Incorporation of the fiber reinforcement increases the tensile strength of the component, however it may also reduce the strain at break therefore a careful balance must be struck to maintain sufficient elongation and ensure durability of the non-metallic component. Therefore, one embodiment includes less than 50% fiber reinforcement, while in an even further embodiment has 5-40% fiber reinforcement, and yet another embodiment has 10-30% fiber reinforcement. Long fiber reinforced non-metallic materials, and the resulting melt properties, produce a more isotropic material than that of short fiber reinforced non-metallic materials, primarily due to the three-dimensional network formed by the long fibers developed during injection molding. Another advantage of long-fiber material is the almost linear behavior through to fracture resulting in less deformation at higher stresses.

Some examples of metals and metal alloys that can be used to form the metallic component include, without limitation, magnesium alloys, aluminum/aluminum alloys (e.g., 3000 series alloys, 5000 series alloys, 6000 series alloys, such as 6061-T6, and 7000 series alloys, such as 7075), titanium alloys (e.g., 3-2.5, 6-4, SP700, 15-3-3-3, 10-2-3, or other alpha/near alpha, alpha-beta, and beta/near beta titanium alloys), carbon steels (e.g., 1020 or 8620 carbon steel), stainless steels (e.g., 304, 410, 416 stainless steel), PH (precipitation-hardenable) alloys (e.g., 17-4, C450, or C455 alloys), copper alloys, and nickel alloys. Some examples of polymers that can be used to form the non-metallic component include, without limitation, thermoplastic materials (e.g., polyethylene, polypropylene, polystyrene, acrylic, PVC, ABS, polycarbonate, polyurethane, polyphenylene oxide (PPO), polyphenylene sulfide (PPS), polyether block amides, nylon, and engineered thermoplastics), thermosetting materials (e.g., polyurethane, epoxy, and polyester), copolymers, and elastomers (e.g., natural or synthetic rubber, EPDM, and compounds thereof). In one particular embodiment the metallic material has Rockwell hardness value of at least 25, while a further embodiment has a Rockwell hardness value of at least 28, while an even further embodiment has a Rockwell hardness value of 30-40, thereby further promoting smooth operation of the interface and desired wear tendencies.

Numerous alterations, modifications, and variations of the preferred embodiments disclosed herein will be apparent to those skilled in the art and they are all anticipated and contemplated to be within the spirit and scope of the instant invention. For example, although specific embodiments have been described in detail, those with skill in the art will understand that the preceding embodiments and variations can be modified to incorporate various types of substitute and or additional or alternative materials, relative arrangement of elements, and dimensional configurations. Accordingly, even though only few variations of the present invention are described herein, it is to be understood that the practice of such additional modifications and variations and the equivalents thereof, are within the spirit and scope of the invention as defined in the following claims. The corresponding structures, materials, acts, and equivalents of all means or step plus function elements in the claims below are intended to include any structure, material, or acts for performing the functions in combination with other claimed elements as specifically claimed.

We claim:

1. A product slicer (100), comprising:
a housing (200);
a knife (300) mounted to the housing (200) and rotatable about a knife axis (310), the knife (300) having a knife cutting edge (320) defining a knife cutting plane;
a carriage assembly (400) mounted to the housing (200) and configured for reciprocating motion past the knife cutting edge (310);
an adjustable gauge plate (500) mounted to the housing (200) and having a gauge plate bearing surface (530), wherein the adjustable gauge plate (500) is adjustable in an adjustment direction from a gauge plate initial position, with at least a portion of the gauge plate bearing surface (530) substantially in the knife cutting plane, to a gauge plate slicing position, with at least a portion of the gauge plate bearing surface (530) offset from the knife cutting plane;
a cam plate (700) rotably mounted to the housing (200), the cam plate (700) having a cam plate center axis (760) and a cam plate channel (740);
a cam follower (800) having a cam follower head (810) engaging the cam plate channel (740), wherein the cam follower (800) is connected to a slider assembly (900) that is connected to the adjustable gauge plate (500);
wherein at the gauge plate initial position the cam follower head (810) engages the cam plate channel (740) at an initial cam head position (860), and rotation of the cam plate (700) through a slicing angle moves the cam follower head (810) within the cam plate channel (740) to a slicing cam head position (870) causing movement of the slider assembly (900) and the adjustable gauge plate (500) to the gauge plate slicing position; and
wherein the cam plate channel (740) has a first channel sidewall (742), with at least a portion oriented at a first sidewall angle (743) greater than zero, a second channel sidewall (744), with at least a portion oriented at a second sidewall angle (745) greater than zero, a channel exterior width (748), and a channel interior width (750), and wherein at least a portion of the cam follower head (810) has an angled head surface oriented at a cam follower pitch (818) that is greater than zero.

2. The product slicer (100) of claim 1, further including a cam-to-follower biasing mechanism (1000) to bias the cam follower head (810) and the cam plate (700) against one another.

3. The product slicer (100) of claim 2, wherein the cam-to-follower biasing mechanism (1000) includes a cam follower biasing mechanism (1010) that exerts a biasing force to force the cam follower (800) against the cam plate (700).

4. The product slicer (100) of claim 3, wherein the biasing force is at least 2 lbf.

5. The product slicer (100) of claim 4, wherein the biasing force is less than 12 lbf.

6. The product slicer (100) of claim 3, wherein the biasing force is adjustable.

7. The product slicer (100) of claim 6, wherein the position of the cam follower (800) is adjustable and repositioning of the cam follower (800) changes the compression of the cam follower biasing mechanism (1010).

8. The product slicer (100) of claim 1, wherein the first sidewall angle (743) is greater than five degrees, the second sidewall angle (745) is greater than five degrees, and the cam follower pitch (818) is within 2.5 degrees of the first sidewall angle (743) and the second sidewall angle (745).

9. The product slicer (100) of claim 8, wherein the first sidewall angle (743) is 5-45 degrees, the second sidewall angle (745) is 5-45 degrees, and the cam follower pitch (818) is 5-45 degrees.

10. The product slicer (100) of claim 1, wherein the cam follower head (810) is frustoconical having a cam follower distal head width (814) and a cam follower proximal head width (816), and wherein the cam follower distal head width (814) is at least 20% less than the cam follower proximal head width (816).

11. The product slicer (100) of claim 10, wherein the cam follower distal head width (814) is 20-60% less than the cam follower proximal head width (816).

12. The product slicer (100) of claim 11, wherein the cam follower proximal head width (816) is greater than the channel exterior width (748).

13. The product slicer (100) of claim 1, wherein the cam plate channel (740) has a channel depth (752) and a channel converging sidewall depth (753), and the cam follower head (810) has a cam follower head length (812) that is less than the channel depth (752).

14. The product slicer (100) of claim 13, wherein the channel converging sidewall depth (753) is less than the cam follower head length (812).

15. The product slicer (100) of claim 14, wherein the channel converging sidewall depth (753) is at least 30% of the channel depth (752).

16. A product slicer (100), comprising:
a housing (200);
a knife (300) mounted to the housing (200) and rotatable about a knife axis (310), the knife (300) having a knife cutting edge (320) defining a knife cutting plane;
a carriage assembly (400) mounted to the housing (200) and configured for reciprocating motion past the knife cutting edge (310);
an adjustable gauge plate (500) mounted to the housing (200) and having a gauge plate bearing surface (530), wherein the adjustable gauge plate (500) is adjustable in an adjustment direction from a gauge plate initial position, with at least a portion of the gauge plate bearing surface (530) substantially in the knife cutting plane, to a gauge plate slicing position, with at least a portion of the gauge plate bearing surface (530) offset from the knife cutting plane;
a cam plate (700) rotably mounted to the housing (200), the cam plate (700) having a cam plate center axis (760) and a cam plate channel (740);
a cam follower (800) having a cam follower head (810) engaging the cam plate channel (740), wherein the cam follower (800) is connected to a slider assembly (900) that is connected to the adjustable gauge plate (500);
a cam-to-follower biasing mechanism (1000) to bias the cam follower head (810) and the cam plate (700) against one another with a biasing force of at least 2 lbf;
wherein at the gauge plate initial position the cam follower head (810) engages the cam plate channel (740) at an initial cam head position (860), and rotation of the cam plate (700) through a slicing angle moves the cam follower head (810) within the cam plate channel (740) to a slicing cam head position (870) causing movement of the slider assembly (900) and the adjustable gauge plate (500) to the gauge plate slicing position; and
wherein the cam plate channel (740) has a first channel sidewall (742), with at least a portion oriented at a first sidewall angle (743) greater than five degrees, a second channel sidewall (744), with at least a portion oriented at a second sidewall angle (745) greater than five degrees, a channel exterior width (748), and a channel interior width (750), and wherein at least a portion of the cam follower head (810) has an angled head surface oriented at a cam follower pitch (818) that is greater than zero.

17. The product slicer (100) of claim 16, wherein the biasing force is adjustable.

18. The product slicer (100) of claim 17, wherein the position of the cam follower (800) is adjustable and repositioning of the cam follower (800) changes the compression of the cam follower biasing mechanism (1010).

19. The product slicer (100) of claim 16, wherein the cam follower head (810) is frustoconical having a cam follower distal head width (814) and a cam follower proximal head width (816), and wherein the cam follower distal head width (814) is at least 20% less than the cam follower proximal head width (816).

20. The product slicer (100) of claim 19, wherein the cam follower distal head width (814) is 20-60% less than the cam follower proximal head width (816), the cam follower proximal head width (816) is greater than the channel exterior width (748), and the cam plate channel (740) has a channel depth (752) and a channel converging sidewall depth (753), wherein the cam follower head (810) has a cam follower head length (812) that is less than the channel depth (752).
